(19) United States
(12) Patent Application Publication
(10) Pub. No.: US 2009/0209348 A1
(43) Pub. Date: Aug. 20, 2009

(54) LIVE IN-GAME SPECTATOR FOR USE IN TELEVISION PRODUCTION

(75) Inventors: STEVEN F. ROBERTS, San Francisco, CA (US); Michael Burks, San Francisco, CA (US); Han Park, Edgewater, NJ (US); Craig Levine, New York, NY (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(73) Assignee: THE DIRECTV GROUP, INC., El Segundo, CA (US)

(21) Appl. No.: 12/335,465

(22) Filed: Dec. 15, 2008

Related U.S. Application Data
(60) Provisional application No. 61/013,744, filed on Dec. 14, 2007.

(51) Int. Cl. A63F 13/00

(52) U.S. Cl. 463/40

(57) ABSTRACT

Systems, methods, and devices for presenting video game contests via television are presented. A system in accordance with one or more embodiments of the present invention comprises a network of gaming platforms, wherein the network of gaming platforms comprise at least one player platform and at least one spectator platform, the at least one spectator platform having a viewing perspective different from that of the at least one player platform, each gaming platform in the network of gaming platforms having a video output, a plurality of converters, each converter in the plurality of converters respectively coupled to the video outputs of the gaming platforms, a production facility, coupled to the plurality of converters, for viewing the video outputs of the gaming platforms via the plurality of converters and for selecting a chosen video output to be broadcast, and a broadcast system, coupled to the production facility, for distributing the chosen video output.

### CROSS-REFERENCE TO RELATED APPLICATIONS

This application claims the benefit under 35 U.S.C. Section 119(e) of U.S. Provisional Application Ser. No. 61/013,744, filed on Dec. 14, 2007, by Steven Roberts et al., entitled “LIVE IN-GAME SPECTATOR FOR USE IN TELEVISION PRODUCTION,” which application is incorporated by reference herein.

This application is related to U.S. patent application Ser. No. ______, filed same date herewith, which claims the benefit under 35 U.S.C. Section 119(e) of U.S. Provisional Application Ser. No. 61/013,741, filed on Dec. 14, 2007, by Steven Roberts et al., entitled “START OF GAME DELAY VIA SPECTATOR FUNCTION FOR USE IN TELEVISION PRODUCTION,” which applications are incorporated by reference herein.

### BACKGROUND OF THE INVENTION

1. Field of the Invention

The present invention relates generally to video games, and in particular to the use of live, in-game spectators for use in television production.

2. Background of the Invention

Since the 1970's, video games have grown in popularity and are now in widespread use throughout the world. Video games are now in use on several platforms, such as personal computers, as well as proprietary platforms such as XBOX360, Playstation 3, and Wii. Each platform supports different functionalities, uses different controllers, and has different games available for use and enjoyment.

It has been difficult, however, to expand the video game industry to beyond the player's personal experience. Organized sports, such as football, baseball, and basketball, have garnered large audiences through television, and boxing and other less frequent events have been able to use pay-per-view avenues to garner increased revenues and interest. Video games, on the other hand, have been typically a user-only experience.

Recently, the ability to insert “spectators” into some games has become available, and such technology is described in U.S. Pat. No. 6,999,083, which is incorporated by reference herein. However, this technology still limits the ability of a large number of users to view a particular game or contest, because each person must insert an individual “spectator” into the game of interest.

From the foregoing, it can be seen, then, that there is a need in the art for a method to show video games to a larger audience. It can also be seen, then that there is a need in the art for an apparatus that enables a larger audience to watch a video game contest.

### SUMMARY OF THE INVENTION

To minimize the limitations in the prior art, and to minimize other limitations that will become apparent upon reading and understanding the present specification, the present invention discloses systems, methods, and apparatuses for presenting video game contests via television.

A system in accordance with one or more embodiments of the present invention comprises a network of gaming platforms, wherein the network of gaming platforms comprise at least one player platform and at least one spectator platform, the at least one spectator platform having a viewing perspective different from that of the at least one player platform, each gaming platform in the network of gaming platforms having a video output; a plurality of converters, each converter in the plurality of converters respectively coupled to the video outputs of the gaming platforms, a production facility, coupled to the plurality of converters, for viewing the video outputs of the gaming platforms via the plurality of converters and for selecting a chosen video output to be broadcast, and a broadcast system, coupled to the production facility, for distributing the chosen video output.

Such a system further optionally comprises the broadcast system distributing the chosen video output substantially in real-time, the network of gaming platforms being a network of computers, a server, wherein each computer in the network of computers is coupled to the server, the at least one spectator platform being controlled separately from the at least one player platform, the at least one spectator platform having additional capabilities compared to the at least one player platform, one of the at least one player platforms acting as a host for the at least one spectator platform, a plurality of sound boxes, respectively coupled to an audio output of each of the gaming platforms in the network of gaming platforms, and the production facility being further coupled to the plurality of sound boxes, and wherein when the chosen video output is selected, the audio output corresponding to the chosen video output is also selected for distribution via the broadcast system.

A method for presenting a video game contest via a broadcast system in accordance with one or more embodiments of the present invention comprises generating a video output from each of a plurality of gaming platforms, wherein the plurality of gaming platforms comprises at least one player platform and at least one spectator platform, the at least one spectator platform having a viewing perspective different from that of the at least one player platform, selecting at least one of the video outputs from at least one of the plurality of gaming platforms, and broadcasting the selected video output.

Such a method further optionally comprises the broadcast system distributing the selected video output substantially in real-time, the plurality of gaming platforms being a plurality of computers, the at least one spectator platform having additional capabilities compared to the at least one player platform, and one of the at least one player platforms acting as a host for the at least one spectator platform.

A receiver for receiving a video game contest via a broadcast system in accordance with one or more embodiments of the present invention comprises a video input, wherein the video input receives a video signal comprising at least a video selected from a plurality of gaming platforms, the plurality of gaming platforms comprising at least one player platform and at least one spectator platform, the at least one spectator platform having a viewing perspective different from that of the at least one player platform, a processor, coupled to the video input, wherein the processor processes the video signal such that the video signal is formatted for presentation on a monitor, and at least one video output, coupled to the processor, wherein the video output comprises the formatted video signal.

Such a receiver further optionally comprises the broadcast system being a satellite broadcast system, the broadcast system distributing the selected video output substantially in real-time, the plurality of gaming platforms being a plurality of computers, the at least one spectator platform having additional capabilities compared to the at least one player platform, and one of the at least one player platforms acting as a host for the at least one spectator platform.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 illustrates a computer configuration in accordance with one or more embodiments of the present invention;

FIG. 3 illustrates the television production connections in accordance with one or more embodiments of the present invention;

FIG. 4 illustrates a gaming platform configuration in accordance with one or more embodiments of the present invention;

FIG. 5 illustrates a head-to-head game platform configuration in accordance with one or more embodiments of the present invention;

FIG. 6 illustrates a typical satellite television system of the related art; and

FIG. 7 illustrates a process chart in accordance with one or more embodiments of the present invention.

### DETAILED DESCRIPTION

In the following description, reference is made to the accompanying drawings which form a part hereof, and which is shown, by way of illustration, several embodiments of the present invention. It is to be understood that other embodiments may be utilized and structural changes may be made without departing from the scope of the present invention.

### Overview

The invention is a network of personal computers, or a group of interconnected gaming platforms (collectively called gaming stations), where some of the gaming stations are “spectators” in the game being contested. The players each see the game from a first person perspective, and the spectators each see the game from a third person perspective. The spectators are “invisible” as far as the players are concerned, in that the spectator does not have a character that can be seen by the players during the game.

Each of the gaming stations, including the spectator gaming stations, is connected to a converter that converts the video and audio signals into standard television signals. The spectators typically follow the players or are stationed to watch for specific events to occur during the game, and each of the spectator and player video/audio signals are sent to the production truck for live selection of video/audio to be sent out over the airwaves.

### Environment

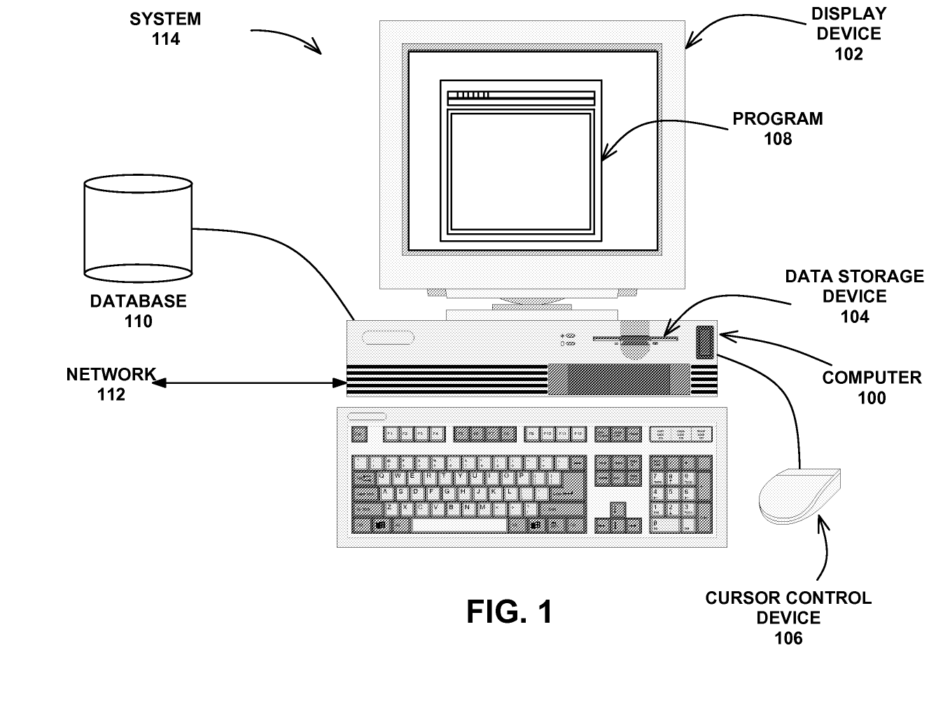

FIG. 1 is an exemplary hardware and software environment used to implement one or more embodiments of the invention.

Embodiments of the invention are typically implemented using a computer 100, which generally includes, inter alia, a display device 102, data storage devices 104, cursor control devices 106, and other devices. Those skilled in the art will recognize that any combination of the above components, or any number of different components, peripherals, and other devices, may be used with the computer 100.

One or more embodiments of the invention are implemented by a computer-implemented program 108, wherein the program 108 is represented by a window displayed on the display device 102.

Generally, the program 108 comprises logic and/or data embodied in or readable from a device, media, carrier, or signal, e.g., one or more fixed and/or removable data storage devices 104 connected directly or indirectly to the computer 100, one or more remote devices coupled to the computer 100 via a data communications device, etc. Further, the program 108 may utilize a database 110 such as a spatial database.

Computer 100 may also be connected to other computers 100 (e.g., a client or server computer) via network 112 comprising the Internet, LANs (local area network), WANs (wide area network), or the like. Further, database 110 may be integrated within computer 100 or may be located across network 112 on another computer 100 or accessible device.

Those skilled in the art will recognize that the exemplary system illustrated in FIG. 1 is not intended to limit the present invention. Indeed, those skilled in the art will recognize that other alternative systems may be used without departing from the scope of the present invention.

### Gaming Configurations

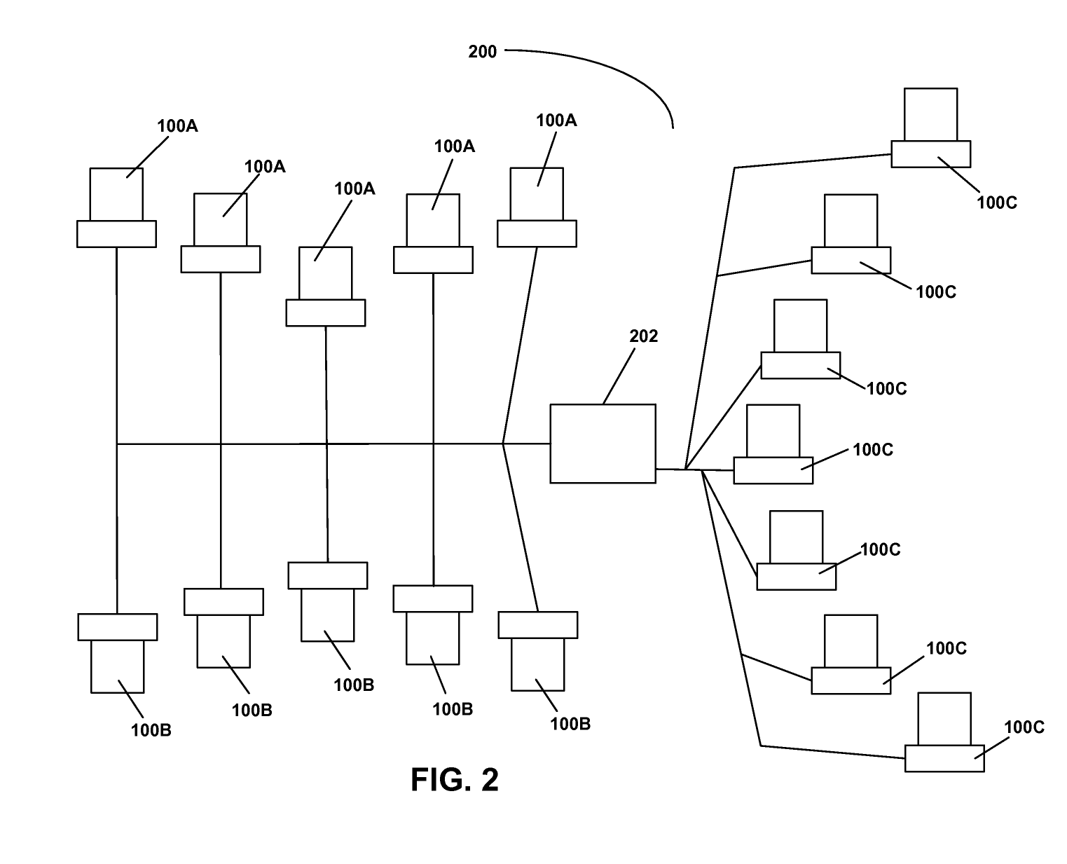

FIG. 2 illustrates a computer configuration in accordance with one or more embodiments of the present invention.

Configuration 200 is shown, where computer 100 takes one of three “forms” as described herein. Computers 100A are computers 100 set up for a given player “team” of players, computers 100B are computers 100 set up for a second “team” of players, and computers 100C are computers 100 set up for a group of “spectators” that are watching the players using computers 100A and 100B. Larger or smaller numbers of computers 100A, 100B, and/or 100C can be used without departing from the scope of the present invention. All of the computers 100A, 100B, and 100C are coupled to a server 202.

So, for example, and not by way of limitation, a contest of the game “Counter Strike: Source” can be waged between two teams of five players each. Each player on team 1 occupies a computer 100A, and each player on team 2 occupies a computer 100B. A separate group of spectators occupy computers 100C.

The spectator computers 100C are viewing the game being played between the players using computers 100A and the players using computers 100B. Further, players using computers 100A and 100B cannot access the viewpoints of spectators 100C, and do not know that computers 100C even exist within the contested game. The spectator computers 100C are “invisible” to the players using computers 100A and 100B.

The connection to the server 202 enables the computers 100A, 100B, and 100C to communicate properly with each other in a local area network environment. As such, each computer 100, separately running the game program, is synchronized and playing or watching the same game being contested between the players using computers 100A and the players using computers 100B. Server 202 can also run the game program and enable each of the computers 100A, 100B, and 100C to participate in the game as multi-players and multi-spectators if such a configuration is desired.

### Television Production and Transmission

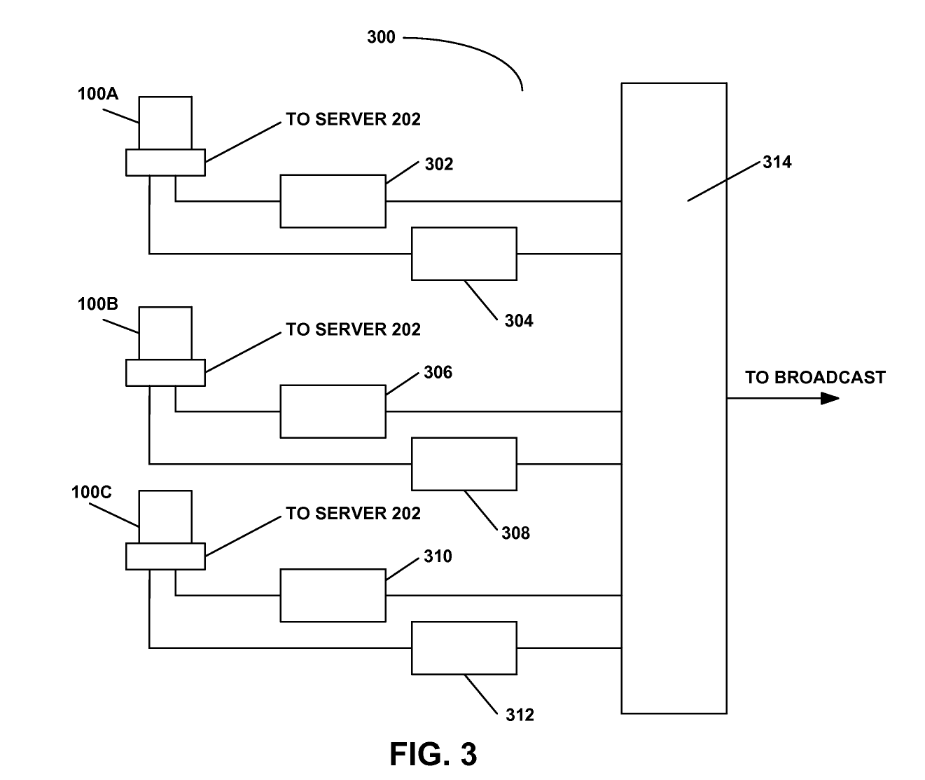

FIG. 3 illustrates the television production connections in accordance with one or more embodiments of the present invention.

System 300 shows the connections of computers 100A, 100B, and 100C to other instrumentation to enable the live broadcast of the game contest. Although only one computer 100A, 100B, and 100C are shown for reasons of clarity, it is within the scope of the present invention to connect each of the computers 100A, 100B, and 100C as described in FIG. 3.

Each computer 100A, 100B, and 100C, is not only coupled to server 202, but also to other electronics to couple the audio and video signals that are being shown on monitors coupled to computers 100A, 100B, and 100C to a production facility.

As shown in FIG. 3, computer 100A is coupled to sound box 302, such that the audio being generated at computer 100A is also being transmitted electronically to sound box 302. Similarly, computer 100A is coupled to a video converter 304, also called a Folsom converter, which converts the graphics that are shown on the monitor coupled to computer 100A to standard television signals.

In a similar fashion, computer 100B is coupled to sound box 306 and converter 308, and computer 100C is coupled to sound box 310 and converter 312. Sound boxes 302, 306, and 310, and converters 304, 308, and 312, are all coupled to production facility 314.

Within production facility 314, each of the audio/video outputs from computers 100A, 100B, and 100C are shown in real-time. A switching facility allows a producer to select which of the audio/video outputs to be broadcast over television airwaves, via cable, or via satellite subscription television techniques.

As such, the present invention allows for live overview perspectives of the game being contested via the audio/video from computer(s) 100C, as well as first person perspectives from the audio/video from computers 100A and/or 100B. Within production facility 314, each of the contested games can now be shown as if it were a live sporting event, e.g., the “player perspective” being similar to close-ups of a batter in baseball or a camera angle from behind the quarterback in football, and the “spectator” perspective being similar to the wide shot or the dirigible shot from above the stadium.

Each of the spectator computers 100C can be given a “script” to follow such that the production facility will have footage that may be interesting to viewers that are watching the contest via television. So, for example and not by way of limitation, one of the computer 100C operators can be asked to stay near one of the players on team A, e.g., one of the players using one of the computers 100A. Rather than having the spectator remain behind the player, the spectator can discuss with other spectators where players from computer(s) 100B are, so the spectator can get ready for a better “camera” angle to show the outside viewing audience. Further, spectator computers 100C can know, in advance, where certain battles or events will occur in the contest between computers 100A and 100B, and can select their spectator viewpoint near or at those locations to see the contest from that point of view.

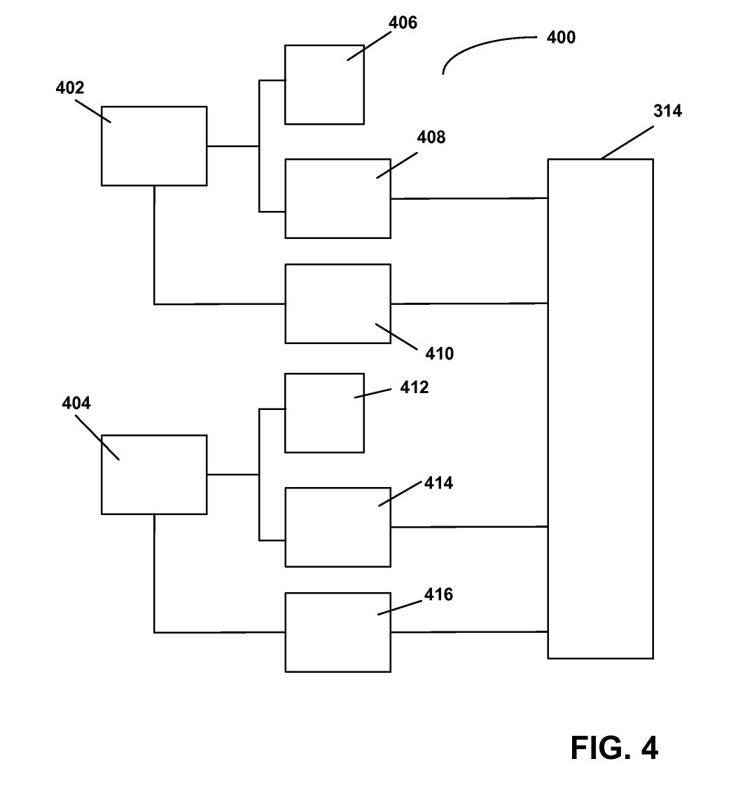

FIG. 4 illustrates a gaming platform configuration in accordance with one or more embodiments of the present invention.

System 400 shows gaming platforms 402 and 404. Additional gaming platforms can also be connected if desired without departing from the scope of the present invention.

One or more gaming platforms 402 are used for player interaction, while one or more gaming platforms 404 are used for spectators. Gaming platform 402 is coupled to a monitor 406, and the video output signals from gaming platform 402 are split off to a converter box 408, similar to that described in FIG. 3. Audio signals from gaming platform 402 are sent to a sound box 410 similar to those described in FIG. 3. The outputs of converter 408 and sound box 410 are sent to production facility 314 as described above.

Gaming platform 404 is also coupled to a monitor 412, converter 414, and sound box 416 in a similar fashion. One of the gaming platforms 402 or 404 is a host of the game being played, and the other platform(s) 402 and 404 are clients, such that the game being contested is only hosted on one of the platforms 402-404.

As with the configuration described in FIGS. 2-3, some of the gaming platforms 402 are for players, and other gaming platforms 404 are for spectators. The spectator platforms 404 are entered into the game to provide the production facility with different “virtual camera” angles to be shown on television screens that are remote from the place where the game is being contested.

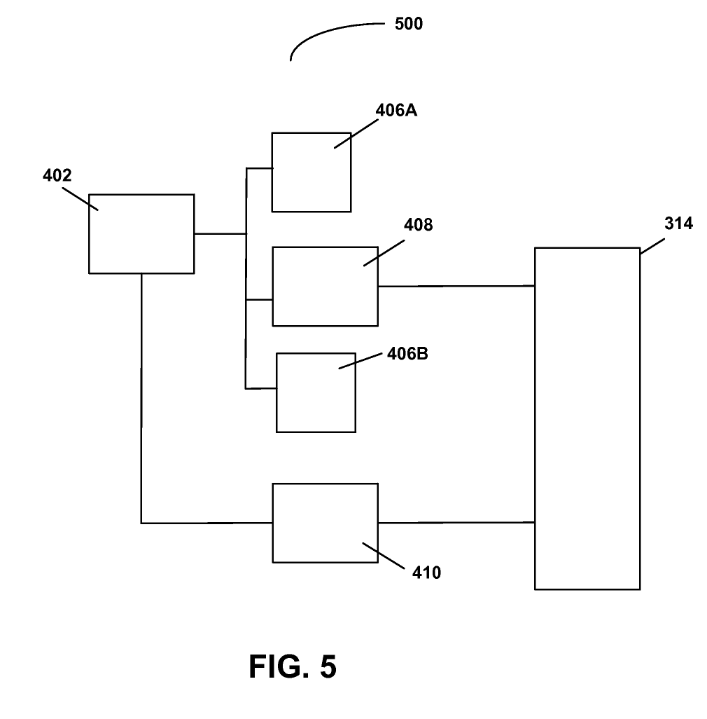

FIG. 5 illustrates a head-to-head game platform configuration in accordance with one or more embodiments of the present invention.

For games that either cannot have a spectator platform 404 inserted as a client, or for games that are head-to-head where only two perspectives would be of interest to the remote viewers, a single gaming platform 402 has two monitors 406A and 406B connected, and the video is split from those monitors via converter 408. Audio is still connected via sound box 410, and the outputs of converter 408 and sound box 410 are sent to production facility 314.

### Broadcast Distribution

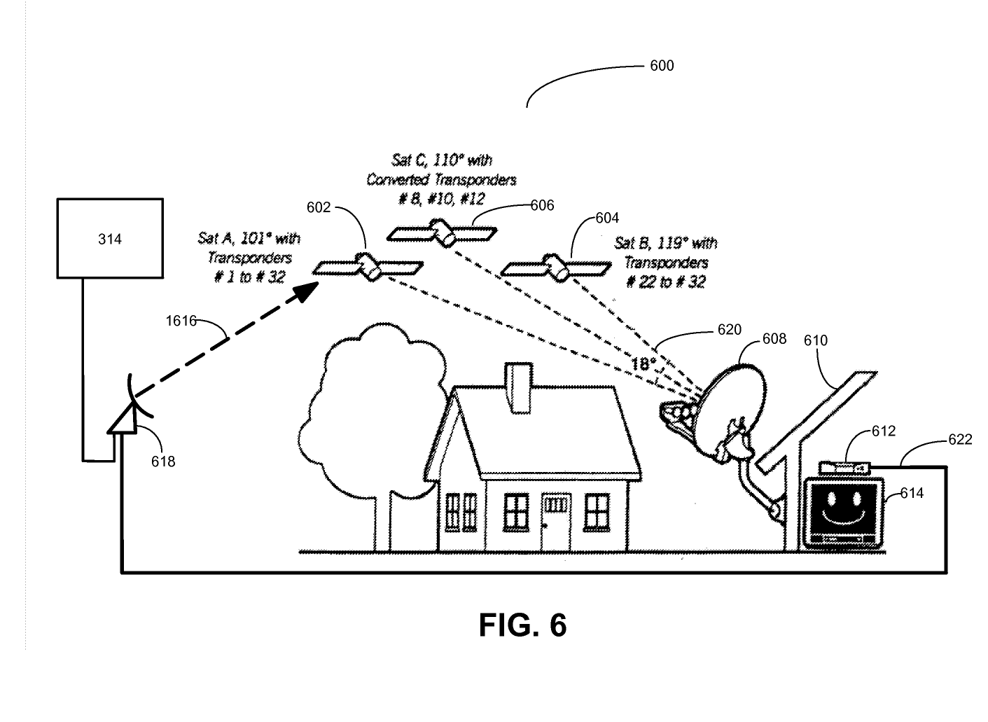

FIG. 6 illustrates a typical satellite television system of the related art.

To distribute the signals from production facility 314, several systems can be used. For example, a satellite distribution system 600 uses signals sent from Satellite A (SatA) 602, Satellite B (SatB) 604, and Satellite C (SatC) 606 that are directly broadcast to an Outdoor Unit (ODU) 608 that is typically attached to the outside of a house 610. ODU 608 typically includes an antenna that receives these signals and sends the received signals to a receiver, typically called an Integrated Receiver Decoder (IRD) 612, which decodes the signals and separates the signals into viewer channels, which are then passed to monitor 614 for viewing by a user. There can be more than one satellite transmitting from each orbital location.

Satellite uplink signals 616 are transmitted by one or more uplink facilities 618 to the satellites 602-604 that are typically in geosynchronous orbit. Satellites 602-606 amplify and rebroadcast the uplink signals 616, through transponders located on the satellite, as downlink signals 620. Depending on the satellite 602-606 antenna pattern, the downlink signals 620 are directed towards geographic areas for reception by the ODU 608.

Each satellite 602-606 broadcasts downlink signals 620 in typically thirty-two (32) different frequencies, which are licensed to various users for broadcasting of programming, which can be audio, video, or data signals, or any combination. These signals are typically located in the Ku-band of frequencies, i.e., 11-18 GHz. Future satellites will likely broadcast in the Ka-band of frequencies, i.e., 18-40 GHz, but typically 20-30 GHz.

Production facility 314 connect to uplink facility 618 to send the broadcast signals received from computers 100A-100C or gaming platforms 402-404 directly to satellites 602-606 for broadcast to IRDs 612, which receive the signals 620 via a video input, process the signals with a processor such that signals 620 are viewable on monitors 614 within the satellite downlink signal 620 transmission area, and output the signals via a video output to monitor(s) 614. Similarly, cable distribution system 622 can be used, or other on-air distribution systems, e.g., direct transmission from facility 618 as in over-the-air television signals, are also possible within the scope of the present invention. Such distribution can be either real-time, e.g., live or without significant delay from the events taking place on computers 100 or gaming platforms 402-404, or recorded and distributed at a time convenient to the broadcaster.

### Process Chart

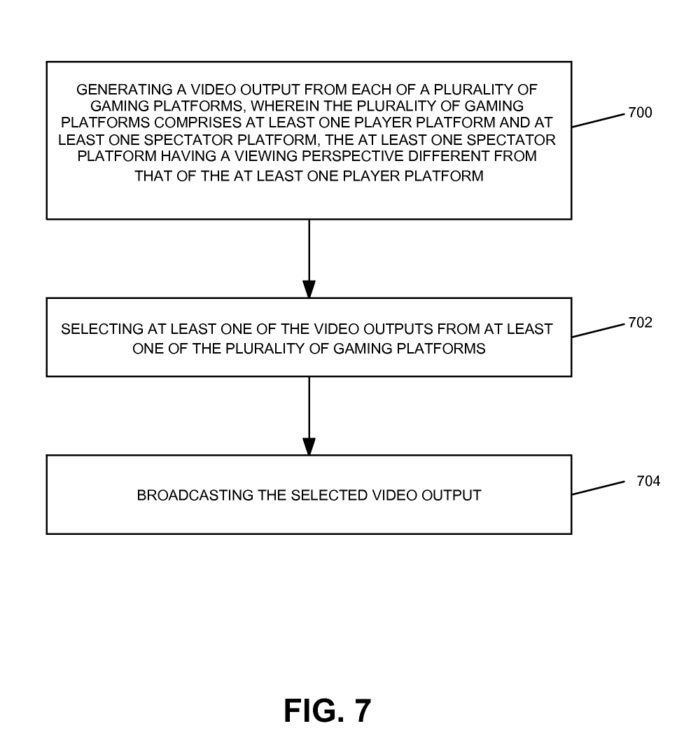

FIG. 7 illustrates a process chart in accordance with one or more embodiments of the present invention.

Box 700 illustrates generating a video output from each of a plurality of gaming platforms, wherein the plurality of gaming platforms comprises at least one player platform and at least one spectator platform, the at least one spectator platform having a viewing perspective different from that of the at least one player platform.

Box 702 illustrates selecting at least one of the video outputs from at least one of the plurality of gaming platforms.

Box 704 illustrates broadcasting the selected video output.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention. Further, other gaming platforms, distribution systems, and games can be used within the scope of the present invention.

The present invention discloses systems for presenting video game contests via television. A system in accordance with one or more embodiments of the present invention comprises a network of gaming platforms, wherein the network of gaming platforms comprise at least one player platform and at least one spectator platform, the at least one spectator platform having a viewing perspective different from that of the at least one player platform, each gaming platform in the network of gaming platforms having a video output; a plurality of converters, each converter in the plurality of converters respectively coupled to the video outputs of the gaming platforms, a production facility, coupled to the plurality of converters, for viewing the video outputs of the gaming platforms via the plurality of converters and for selecting a chosen video output to be broadcast, and a broadcast system, coupled to the production facility, for distributing the chosen video output.

Such a system further optionally comprises the broadcast system distributing the chosen video output substantially in real-time, the network of gaming platforms being a network of computers, a server, wherein each computer in the network of computers is coupled to the server, the at least one spectator platform being controlled separately from the at least one player platform, the at least one spectator platform having additional capabilities compared to the at least one player platform, one of the at least one player platforms acting as a host for the at least one spectator platform, a plurality of sound boxes, respectively coupled to an audio output of each of the gaming platforms in the network of gaming platforms, and the production facility being further coupled to the plurality of sound boxes, and wherein when the chosen video output is selected, the audio output corresponding to the chosen video output is also selected for distribution via the broadcast system.

A method for presenting a video game contest via a broadcast system in accordance with one or more embodiments of the present invention comprises generating a video output from each of a plurality of gaming platforms, wherein the plurality of gaming platforms comprises at least one player platform and at least one spectator platform, the at least one spectator platform having a viewing perspective different from that of the at least one player platform, selecting at least one of the video outputs from at least one of the plurality of gaming platforms, and broadcasting the selected video output.

Such a method further optionally comprises the broadcast system distributing the selected video output substantially in real-time, the plurality of gaming platforms being a plurality of computers, the at least one spectator platform having additional capabilities compared to the at least one player platform, and one of the at least one player platforms acting as a host for the at least one spectator platform.

A receiver for receiving a video game contest via a broadcast system in accordance with one or more embodiments of the present invention comprises a video input, wherein the video input receives a video signal comprising at least a video selected from a plurality of gaming platforms, the plurality of gaming platforms comprising at least one player platform and at least one spectator platform, the at least one spectator platform having a viewing perspective different from that of the at least one player platform, a processor, coupled to the video input, wherein the processor processes the video signal such that the video signal is formatted for presentation on a monitor, and at least one video output, coupled to the processor, wherein the video output comprises the formatted video signal.

Such a receiver further optionally comprises the broadcast system being a satellite broadcast system, the broadcast system distributing the selected video output substantially in real-time, the plurality of gaming platforms being a plurality of computers, the at least one spectator platform having additional capabilities compared to the at least one player platform, and one of the at least one player platforms acting as a host for the at least one spectator platform.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto and the full range of equivalents to the claims.

What is claimed is:

1. A system for presenting video game contests via television, comprising:
a network of gaming platforms, wherein the network of gaming platforms comprise at least one player platform and at least one spectator platform, the at least one spectator platform having a viewing perspective different from that of the at least one player platform, each gaming platform in the network of gaming platforms having a video output;
a plurality of converters, each converter in the plurality of converters respectively coupled to the video outputs of the gaming platforms;
a production facility, coupled to the plurality of converters, for viewing the video outputs of the gaming platforms via the plurality of converters and for selecting a chosen video output to be broadcast; and
a broadcast system, coupled to the production facility, for distributing the chosen video output.

2. The system of claim 1, wherein the broadcast system distributes the chosen video output substantially in real-time.

3. The system of claim 2, wherein the network of gaming platforms is a network of computers.

4. The system of claim 3, further comprising a server, wherein each computer in the network of computers is coupled to the server.

5. The system of claim 1, wherein the at least one spectator platform is controlled separately from the at least one player platform.

6. The system of claim 1, wherein the at least one spectator platform has additional capabilities compared to the at least one player platform.

7. The system of claim 1, wherein one of the at least one player platforms acts as a host for the at least one spectator platform.

8. The system of claim 1, further comprising a plurality of sound boxes, respectively coupled to an audio output of each of the gaming platforms in the network of gaming platforms.

9. The system of claim 8, wherein the production facility is further coupled to the plurality of sound boxes, and wherein when the chosen video output is selected, the audio output corresponding to the chosen video output is also selected for distribution via the broadcast system.

10. A method for presenting a video game contest via a broadcast system, comprising:
generating a video output from each of a plurality of gaming platforms, wherein the plurality of gaming platforms comprises at least one player platform and at least one spectator platform, the at least one spectator platform having a viewing perspective different from that of the at least one player platform;
selecting at least one of the video outputs from at least one of the plurality of gaming platforms; and
broadcasting the selected video output.

11. The method of claim 10, wherein the broadcast system distributes the selected video output substantially in real-time.

12. The method of claim 10, wherein the plurality of gaming platforms is a plurality of computers.

13. The method of claim 10, the at least one spectator platform has additional capabilities compared to the at least one player platform.

14. The method of claim 10, wherein one of the at least one player platforms acts as a host for the at least one spectator platform.

15. A receiver for receiving a video game contest via a broadcast system, comprising:
a video input, wherein the video input receives a video signal comprising at least a video selected from a plurality of gaming platforms, the plurality of gaming platforms comprising at least one player platform and at least one spectator platform, the at least one spectator platform having a viewing perspective different from that of the at least one player platform;
a processor, coupled to the video input, wherein the processor processes the video signal such that the video signal is formatted for presentation on a monitor; and
at least one video output, coupled to the processor, wherein the video output comprises the formatted video signal.

16. The receiver of claim 15, wherein the broadcast system is a satellite broadcast system.

17. The receiver of claim 16, wherein the broadcast system distributes the selected video output substantially in real-time.

18. The receiver of claim 15, wherein the plurality of gaming platforms is a plurality of computers.

19. The receiver of claim 15, the at least one spectator platform has additional capabilities compared to the at least one player platform.

20. The receiver of claim 15, wherein one of the at least one player platforms acts as a host for the at least one spectator platform.
